(19) United States
(12) Patent Application Publication
(10) Pub. No.: US 2007/0257625 A1
(43) Pub. Date: Nov. 8, 2007

(54) Apparatus and Method of Power Control

(76) Inventor: Paul Stanley Brison, Bury (GB)

Correspondence Address: DARBY & DARBY P.C., P.O. BOX 770, Church Street Station, New York, NY, 10008-0770, US

(21) Appl. No.: 10/599,419

(22) PCT Filed: Mar. 29, 2005
(86) PCT No.: PCT/GB05/01196

§ 371 Date: Jun. 25, 2007

(30) Foreign Application Priority Data
Mar. 29, 2004 (GB) 0406983.7

(51) Int. Cl. H05B 37/02

(52) U.S. Cl. 315/291

(57) ABSTRACT

A power controller for controlling power delivery to a light, the power controller having a control unit in a weather proof casing responsive not only to remote power control signals, but also to be responsive to a remote stimulus with which the mode of operation of the power controller may be controlled. The power controller may include the casing, the control unit disposed within the casing, and a heat sink means disposed within the casing in a space between the control unit and parts of the casing, the heat sink means including a group of vane members each positioned in an array of vane members collectively surrounding at least a part of the control unit in which vane members are arranged to partially overlap other vane members (e.g. neighbouring vane of the array) in separated opposition thereto to define fluid ventilation ducts (e.g. for fluid inlet and/or outlet).

The present invention relates to a method and apparatus for the control of power delivery to electrical appliances. In particular, though not exclusively, the present invention concerns the control of electrical power to a light, such as used in an outdoor lighting arrangement.

The remote control of the delivery of power to electrical appliances such as lights commonly involves the variable control of the amount of power delivered. The affect is often to provide a “dimming” control or “dimmer” function which enables a user to remotely vary the radiant power output of a light, such as a domestic light, once the light has been switched on so as to be responsive to remote power control signals. This type of dimmer control is commonly applied to domestic indoor lights which are neither suitable nor intended for outdoor use, and which are arranged to be easily and readily accessible to a user in the home.

Modern dimmer units typically generate a level of EMI (electromagnetic interference) emissions in use, both radiated from components of the dimmer and conducted into the circuit to which the dimmer is connected in use (e.g. a domestic power circuit). In order to minimise such emissions existing dimmer circuits may employ large and expensive filters and suppressors in order to remove/suppress undesirable EMI signals. Such filters/suppressors are increasingly necessary when the power transmission path between the dimmer and the light it serves increases in length. Minimising this path length as much as possible is desirable in order to reduce or remove the need for complex and costly filters/suppressors. Placing the dimmer circuitry in close proximity to the light being served by it reduces this path length, but this may not be possible if the light in question is located outside a building (i.e. outdoors, an outdoor light) and therefore exposed to the elements since e.g. domestic dimmer units are typically unsuited to outdoor placement and use.

Furthermore, the requirement of manually operable control (e.g. “on”) switches and also any other switches for use in programming or controlling/selecting a mode of operation of the device, imposes limitations on the use of such devices. For example, this design also requires that the device in question is located in use at positions enabling the “on”/control switches to be reached by a user, thereby limiting the positions of the device, in use, to accessible locations. Also, the requirement of manual actuation of switch controls and switches renders the devices wholly unsuitable for outdoor use since such use would typically require the device to be protected (e.g. “weatherproofed”) against the elements. Providing a means for protecting such devices from the elements is often at odds with the need to keep the control switches of the device accessible to a user—if it is accessible to the user it is, to some extent, also accessible to e.g. rainwater.

The present invention aims to address at least some of the problems. At its most general, in a first of its aspects, the present inventions proposes protecting the vulnerable parts of a power controller in a casing and arranging the power controller to be responsive not only to remote power control signals, but also to be responsive to a remote stimulus with which the mode of operation of the power controller may be controlled. For example, the power controller may be activated into a given mode (e.g. “on” state) in response to an appropriate remote stimulus, and may be activated into another different mode (e.g. an “off” state) in response to another remote stimulus. The power controller may be responsive to the remote stimulus in any desired way, such as to configure the power controller into any desired mode of operation, the mode being defined in terms of the manner in which the power controller responds to remote power control signals once in a given mode of operation. For example, the remote power control signals may be such as to control the operation of the power controller, in a given mode, to control power delivery to a light (or other electrical appliance) in a predetermined way, whereas in another mode, the power controller may be operable to perform certain functions which it is not otherwise operable to perform (i.e. in a different mode of operation). As a result, the power controller may be switched on and off and may be programmed or rendered programmeable to operate in any desired way using a remote stimulus thereby obviating the need for on/off/mode switches and other control switches at the power controller. Consequently, the power controller may be encased within a fully weatherproof encasing, the weatherproofing ability of which is not compromised by any need to allow access to the parts of the power controller being protected by the casing. The power controller may also be located in places which do not readily permit direct-access to the controller (e.g. on a wall, ceiling or even behind a wall surface) as would be required were manual switches employed, and may be placed outdoors in close proximity to an outdoor light it serves.

Thus, the present invention may provide a method of power control and a power controller suitable for outdoor use and substantially invulnerable to the elements/weather.

In a first of its aspects the present invention may provide a power controller including: a casing; a control unit disposed within the casing being configurable to (e.g. any of a plurality of) modes of operation to control power delivery to a light and being responsive to a stimulus wirelessly conveyed thereto from outside the casing to configure to a selected mode of operation determined by the stimulus, the control unit being arranged to receive control signals wirelessly conveyed thereto from outside the casing and to control said power delivery according to the control signals wherein the response of the control unit to control signals differs according to the mode of operation determined by the stimulus. Accordingly, the remote controllability of not only the power delivery within a given mode of operation of the power controller, but also the remote control of the configuration of the power controller to a desired mode of operation, obviates the need for manually operable control switches at the control unit and thereby enables the control unit to be placed within a casing designed to protect it against the elements enabling the power controller to be used outdoors, or to be used indoors in situations where access to the control unit would be difficult or not possible. It is to be understood that references herein to the delivery of power to a light includes indirect delivery of power via an intermediate power consuming or power regulating device, such as a transformer circuit (e.g. an electronic transformer placed between the power controller and the light).

Preferably, the control unit does not include, or is not operably connected to, manually operable switches and is responsive to remotely conveyed stimuli and control signals instead. The stimulus is preferably wirelessly conveyed by a short-range static (e.g. not radiated) force field such as a static magnetic or electrical force field, whereas preferably the control signals are wirelessly conveyed via different means such as a long-range radiated wave such e.g. an electromagnetic wave (or vice versa). This difference in the physical means via which the stimulus and the control signals are conveyed offers security to the control unit in that the mode of operation may not be accidentally/deliberately altered using the control signals, since only the stimulus, having a different physical form, would be required for that.

The modes of operation to which the control unit may be configurable preferably includes a simple “on” mode configurable from an “off” mode, and vice versa. An “on” mode may be a mode in which the control unit enables power to be delivered to the light, while in the “off” mode, the control unit may inhibit or prevent delivery of power to the light until such time as the control unit is configured to an “on” mode by use of the stimulus. Of course, in an “on” mode, full and complete control of power delivery to the light may be achieved using the control signals (including the delivery of zero power thereto).

Most preferably the control unit is responsive to said stimulus to configure to an activated (e.g. “on”) mode, in which it is operable to controllably deliver power to the light, from a deactivated (e.g. “off”) mode in which it does not deliver power o the light, and vice versa. Preferably, the control unit consumes very little (e.g. a few mW, or less) or substantially no power in the deactivated mode (e.g. is in a “sleep” mode) while still being responsive to said stimulus and preferably also responsive to said control signals.

Preferably, the power controller includes a remote unit outside said casing and operable to wirelessly transmit said control signals to the control unit, in which the control unit is responsive to said stimulus to configure to a programming mode in which it is responsive to said control signals to be programmed thereby to respond in a predetermined way to a predetermined operation of the remote unit. For example, the control unit may be configurable to a programming mode in which it is arranged to receive remote wirelessly transmitted control signals containing programming data, and to respond to those signals by programming itself according to the programming signals to the mode of operation defined by those programming signals and data. This means that, after the programming has been completed, the control unit is subsequently responsive to predetermined remote power control signals by responding in a manner predetermined by the programming it has undergone. In the programming mode, the control unit may be responsive to control signals to be programmed thereby so as to respond in a predetermined way to subsequent wireless stimuli to configure to a mode of operation defined by the programming data conveyed to the control unit in its programming mode by the remote power control signals. In this way, the remote unit may “teach” the control unit how to respond to a specific subsequent stimulus to configure in a specific way, and/or how to respond to specific subsequent control signals wirelessly transmitted to the control unit from the remote unit for the purposes of controlling power delivery to e.g. a light. This enables a user to programme a particular power control function of the power controller in response to a particular action (e.g. a key stroke) at the remote unit. The remote unit may comprise any suitable wireless control handset, or the like, such as would be readily apparent to the skilled person.

The control unit preferably includes a magnetic detector means and the stimulus is a magnetic field strength in response to which the magnetic detector means is operable to generate a configure signal, wherein the control unit is responsive to the configure signal to configure to a mode of operation determined by the configure signal. Of course, other physical stimuli may be employed, however the advantage of magnetic field is its ability to pervade through many transparent and non-transparent materials typically employed in technologies of this type. Electromagnetic or electric field stimuli may be employed in other embodiments.

The power controller may also include a stimulus means remote from the control unit and outside said casing and including a magnetic field means for providing a magnetic field of sufficient strength to be remotely detectable by the magnetic detector. The magnetic field means may be a permanent magnet. The magnetic detector means may include a sensor means including any of: a magnetic reed switch; a Hall-Effect switch, a magnetic relay switch; an inductor coil, and the magnetic detector is preferably responsive to said stimulus using the sensor means. Most preferably, the magnetic detector means is a passive detector that does not require or consume power in operation.

The control unit may be arranged to respond not only to the presence of the stimulus, but also the manner or form in which the stimulus is delivered to the control unit. For example, when the stimulus is conveyed by a magnetic field, the control unit may be operable to respond to different properties of the magnetic field it is arranged to detect, such as the magnitude of the magnetic field, the rate of change of a detected magnetic field strength, or the number of a succession of detections of a magnetic field strength exceeding some predetermined threshold value. In this way, the control units may be arranged to respond only to predetermined and specific stimuli, and to be unresponsive to anything not conforming to this form of stimulus. This enables a control unit to be responsive to specific “coded” stimuli and provides a degree of security against unauthorised or accidental configuration of the control unit.

Most preferably, the control unit is configurable to a selected mode of operation according to any of: the duration of a given configure signal; the number of a succession of configure signals; the rate of receipt of successive configure signals thereby; the magnitude of a given configure signal.

Most preferably the power controller is arranged and designed to be suitable for outdoor use in which the control unit is encased in a substantially watertight weatherproof casing. The casing may be made from a durable plastics material, and is most preferably in the form of a casing platform upon which the control unit is mounted, and a detachable cover or lid attachable to the casing platform at a watertight or weatherproof attachment interface.

The casing may be transparent, therefore enabling visible radiation/light to be used as the means for conveying control signals to the control unit within the casing.

The control signals may be conveyed using any of: Infra-red (IR) light; microwaves; radio waves. The casing need not be transparent when such means are used.

Most preferably the control unit is configurable to a mode of operation in which it is responsive to said control signals to change the amount of electrical power delivered to the light in use to controllably vary the radiant output of the light. Thus, preferably at least one mode of operation of the control unit is a “dimmer” mode enabling the degree and/or timing of “dimming” of a light to be remotely controlled.

The control unit may include a photo-sensor means within the casing for determining the level of ambient illumination outside the casing, and for configuring the control unit to a suitable mode of operation according to the ambient illumination level so determined. For example, a suitable mode may be to stop delivery of power to a light when ambient illumination is measured to be above a predetermined level, and to enable power delivery otherwise.

Preferably, the power controller includes a power source connector means arranged to connect to the power source from which the light receives power in use such that the power from the power source passes through the power controller before reaching the light, wherein the power controller is arranged to control the delivery of power from the power source to the light. For example, the connector means may connect the control unit in series electrical connection to (and between) the power source and the light.

Preferably, the casing includes a plurality of prongs extending outwardly thereof and shaped to be intimately received within a reciprocally shaped socket means of the power source connector means such that the casing is detachably attachable to the power source connector means therewith, the prongs being operably connected to the control unit to convey power from the power source to the light via the control unit when the casing is attached to the power source connector means in use. Preferably the casing has three prongs, most preferably, one prong serves as a power input conductor for conducting power from the power source to the control unit, another is a power output conductor for conducting power to the electrical appliance (e.g. light) from the control unit, and the third is arranged to connect to the neutral terminals of the control unit and the power source.

Thus, the plug-and-socket arrangement enables the control unit and casing to be detachably attached e.g. in series electrical connection with both the power source and the light. The control unit may be arranged to derive its operating power from the power source, or may be independently powered (e.g. by battery).

The encasement of the control unit within a casing, such as one suitable for protecting the encased control unit from the weather, has been found to benefit from the inclusion of a heat sink for conveying heat away from the control unit in order to help prevent the control unit from overheating in use. Overheating may otherwise occur due to the confinement of the control unit within a restricted volume inside the casing. Overheating can damage electrical and electronic components of a control unit suitable for use in the present invention.

The control unit may comprise electronic/electrical circuitry and components such as would be readily apparent to the skilled person. These components may include a signal processor unit for receiving remotely conveyed control signals and configure signals and for responding to those signals to, respectively, control power delivery to the light and to configure the control unit to a desired mode of operation. The control unit may include an Infra-red (IR) sensor, or an aerial, responsive to IR or radio-frequency/microwave remote power control signals and operatively connected to the processor of the control unit. Preferably the control unit employs insulated gate bipolar transistor technology (IGBT) for the purposes of controlling power delivery. Transistors such as this have been found to result in very low noise within the circuitry of the control unit. Preferably the components of the control unit are mounted on a printed circuit board. The general structure of the control unit may be such as would be readily apparent to the skilled person in this field.

In a second of its aspects, the present invention may provide a power controller including: a casing; a control unit disposed within the casing and arranged to control power delivery to a light; a heat sink means disposed within the casing in a space between the control unit and parts of the casing, the heat sink means including a group of vane members each positioned in an array of vane members collectively surrounding at least a part of the control unit in which vane members are arranged to partially overlap other vane members (e.g. neighbouring vane of the array) in separated opposition thereto to define fluid ventilation ducts (e.g. for fluid inlet and/or outlet). Preferably, the vane members extend to collectively define a fluid ventilation conduit in fluid communication with the fluid ventilation ducts and within which the at least a part of the control unit is located, wherein the fluid ventilation conduit has an opening at an end thereof for the inlet/outlet of fluid drawn into (or passing out of) the fluid ventilation conduit e.g. through fluid ventilation ducts. The fluid ventilation ducts may serve as either/both fluid inlet or fluid outlet ventilation ducts enabling the flow of air between the space surrounded by the array of vane members and the space outside the array of vane members between the heat sink and the casing. Most preferably, some or all of the vane members are at least partly interleaved between preceding and succeeding vanes of the array.

Experimentation has shown that providing a heat sink in the form of an array of vane members as described above is surprisingly efficient at cooling a control unit in use. The partially overlapping or interleaving arrangement of neighbouring vane members to provide fluid ventilation ducts, and the collective positioning of the vane members to collectively define a fluid ventilation conduit with fluid inlet/outlet opening at one end has been found to be especially efficient at causing an air flow cycle in which air heated by the control unit is caused to flow along the ventilation conduit towards the opening thereof, and also to expand outwardly of the array of vane members through the ventilation ducts running along the sides of the conduit. As a result air outside the ventilation conduit is caused to be drawn into the ventilation conduit through fluid ventilation ducts positioned along the side of the ventilation conduit and/or underneath the heat sink. The air drawn in through the fluid ventilation ducts has been found to be caused to circulate around and among the components of the control unit, to draw heat from the control unit, to expand as a result and to subsequently flow along the fluid conduit towards the outlet opening at an end thereof, and outwardly through the ventilation ducts again. Once this heated fluid has passed out of the fluid conduit subsequent cooling of this heated air causes the air to descend back towards the heat sink to regions adjacent fluid ventilation inlet ducts so as to be subsequently drawn in to the ventilation conduit through such ducts (or through other ventilation gaps thereabouts) in a repeating air-flow cycle. This repeating airflow cycle continuously cools the parts of the control unit inside the ventilation conduit.

The outlet opening of the fluid ventilation conduit is most preferably in fluid communication with at least some of said fluid ventilation ducts via free space outside the fluid ventilation conduit between the heat sink means and the casing. Thus, whilst in the free space outside the fluid ventilation conduit between the heat sink means and the casing, the heated air may cool down and transfer heat preferably to the outer surface of the heat sink and/or the inner surface of the casing. This transferred heat may then subsequently be radiated away from both the heat sink and the casing. In this way, radiative transfer of heat from the outwardly-presented/visible surfaces of components of the heat sink and power controller may be facilitated by convective heat transfer from the control unit within the heat sink vane array structure. To assist in increasing the efficiency of radiative heat transfer from the heat sink, the surface of the heat sink means presented outwardly towards the casing is preferably matt black in colour, or some other suitable dark colour which enhances the output of thermal radiation therefrom. Preferably the heat sink means is made from a thermally conductive metal, and most preferably the surface of the heat sink presented towards the control unit is polished or otherwise prepared in such a manner as to inhibit the radiation therefrom of thermal radiation.

Preferably some or each of the vane members of the heat sink are substantially flat and generally panel-like structures. Preferably some or each vane member of the array is arranged to face, in part or in whole, the control unit and the inner volume of the ventilation conduit, and to partly face the overlapping part of (e.g. the generally flat surface of) a neighbouring vane member. Preferably some or each of the vane members are arranged in the array to face obliquely generally towards the centre of the fluid ventilation conduit volume. Vanes of the heat sink may be angled relative to the bore of the fluid conduit such that the separation between neighbouring vanes defines a ventilation duct which extends along a direction generally parallel with overlapping parts of neighbouring vane panel structures. Most preferably the vane members of the heat sink are arranged to define ducts which extend obliquely from/towards the inner periphery of the ventilation conduit but not directly towards the centre of the ventilation conduit volume. Most preferably, the vane members of the heat sink are arranged relative to each other so as to define ventilation ducts that extend in a direction from/towards the inner volume of the ventilation conduit chosen to produce or facilitate a non-radial (e.g. swirling) movement of air drawn obliquely into the bore of the ventilation conduit through the ventilation ducts, and/or to produce or facilitate a non-radial (e.g. swirling) movement of air expelled obliquely from the ventilation conduit through the ventilation ducts and into the space between the heat sink and the covering casing parts. The swirling motion serves to better ensure that hidden or obstructed parts of the control unit are encountered by the turbulent or swirling movement of cooling air drawn into the heat sink using the appropriately positioned vane members, it also serves to assist in directing expelled heated air to the outwardly presented surface of the heat sink thereby assisting in transferring heat from the air to the outer surface of the heat sink for subsequent radiative heat transfer thereform, and assists in directing heated swirling air into contact with the inner wall of the casing thereby to assist in transferring heat by conduction through the casing to the outside world. Of course, curved vane members may be used in place of flat vane members, as described above.

Most preferably, the vane members of the heat sink are arranged in such a way that air flow directed radially to/from the control unit or the central region of the fluid conduit, is obstructed (e.g. obliquely) by a face of a vane member thereby redirecting that air flow in a non-radial direction oblique to the control unit and/or the central region of the fluid conduit.

The fluid conduit preferably has a fluid inlet opening at an end of the conduit opposite the end having the fluid outlet opening, and in fluid communication with the free space between the heat sink and the casing outside the heat sink.

The fluid inlet opening may face the part of the casing upon which the control unit is mounted, in spaced opposition thereto. The parts of the heat sink defining the fluid inlet opening preferably surround the control unit.

Terminal ends of the vanes may be free ends collectively defining the opening of the concavity of the heat sink structure. They may be spaced from the opposing surface of the base portion of the casing thereby to allow cooled air to be drawn into the fluid ventilation conduit from outside the heat sink structure.

Preferably, the vane members extend to collectively converge towards the outlet opening such that the fluid ventilation conduit collectively defined by the vane members is substantially conical having an inner bore which reduces towards the outlet opening. That is to say, for example, with vanes of the heat sink member as flat panel-like structures tilted or leaning inwardly generally towards the inner volume of the ventilation conduit defined by the array of vanes, a general conical structure is produced in which the bore of the ventilation conduit defined by the vane members decreases as one progresses along the conduit in a direction towards the outlet opening thereof. The result is a conical structure of inwardly tilted separate vanes/panel structures inwardly tilted towards a common point of convergence and producing a structure resembling a turbine. This turbine-like structure has been found through experiment to significantly enhance heat transfer from the control unit in use to the heat sink by causing the rate of flow of heated air passing along the ventilation conduit towards the outlet opening to increase as the bore of the ventilation conduit decreases. It ensures that heated air moving along the conduit in the direction of vane convergence is more likely to impinge upon a ventilation duct thereby to be obliquely directed outwards of the conduit. This structure is also particularly suitable for use in casings which have a generally hemispherical, cylindrical or conical shape.

Preferably, the vane members are joined by a cover member which extends over or across the control unit and within which is formed an aperture defining the outlet opening. The vane members may extend from the periphery of the cover member and may be integrally formed with the cover member, being joined thereto e.g. at a fold in the material of the cover member.

Preferably, the vane members and the cover member collectively define a concavity within which the control unit is located.

The heat sink may comprise a cup-like structure formed from a plate of deformable material (e.g. metal) from the edges of which an array of separate spaced cuts is formed each of which cuts extends into the plate in a direction convergent with that of the other cuts (e.g. convergent upon a common focus) but which each terminates at the periphery of the cover member to form a radial array of petal structures folded, at the line between neighbouring terminal cut ends, to the same side of the cover member to form the vane members thereby to define a fluid ventilation conduit.

Preferably, the petal structures are folded at a twisting fold to angle the petal structures such that a partial non-contact overlap occurs between neighbouring vane members as a result of the collective folding of the petal structures, thereby to define fluid ventilation ducts.

The control unit may be connected to the heat sink means, and the control unit may be physically attached to the cover member.

Preferably the control unit includes temperature monitor means for measuring the temperature within the casing (e.g. of the control unit) and for configuring the control unit to a deactivated mode when the temperature is measured by the temperature monitor means to exceed a predetermined value. This serves as a failsafe to prevent damage to the control unit due to overheating.

Experimentation has shown that the separation between the overlapping parts of neighbouring vanes in the array of vanes the heat sink means is most preferably at least about 0.5 mm. Preferably, the separation between overlapping parts of neighbouring vanes is substantially constant along the whole extent of the ventilation duct defined thereby.

The cover member may contain a plurality of apertures each of which defines a fluid ventilation outlet opening.

In a third of its aspects, the present invention may provide a power controller according to the invention in its first aspect including any of the features described above in respect of the invention in its second aspect.

It is to be understood that the above aspects of the invention describe embodiments of a method of controlling power delivery to a light according to the present invention. The methods generally embodied by the above apparatus are encompassed within the scope of the present invention.

In a fourth of its aspects, the present invention may provide a method of controlling power delivery to a light including: providing a power controller according to the invention in its first aspect, or its third aspect; wirelessly conveying a stimulus to the power controller from outside the casing thereof to configure to a selected mode of operation determined by the stimulus; wirelessly conveying control signals to the controller from outside the casing to control said power delivery according to the control signals.

The method may include providing said stimulus to configure the control unit to an activated mode in which is responsive to said control signals to controllably deliver power to the light, from a deactivated mode in which it does deliver power to the light, or vice versa.

The method may include wirelessly transmitting said control signals to the control unit after configuring the power controller to a programming mode in which it is responsive to said control signals to be programmed thereby to respond in a predetermined way to subsequent control signals.

Preferably the stimulus is a magnetic field strength, and method preferably includes generating a configure signal using the control unit in response to the stimulus, and configuring the control unit to a mode of operation determined by the configure signal.

The method may include configuring the control unit to a selected mode of operation according to any of: the duration of a given configure signal; the number of a succession of configure signals; the rate of receipt of successive configure signals thereby; the magnitude of a given configure signal.

Preferably, the method includes configuring the control unit to a mode of operation in which it is responsive to control signals to change the amount of electrical power delivered to the light in use to controllably vary the radiant output of the light, and wirelessly transmitting such control signals to the control unit.

The method may include providing a photo-sensor means within the casing for determining the level of ambient illumination outside the casing, and configuring the control unit to a suitable mode of operation according to the ambient illumination level so determined.

Preferably, the method includes connecting the control unit to the power source from which the light receives power in use, and directing the power from the power source through the control unit before reaching the light, and controlling the delivery of power from the power source to the light using the control unit.

Preferably, the method includes measuring the temperature of the control unit and configuring the control unit to a deactivated mode when the temperature is measured to exceed a predetermined value.

There now follow examples of embodiments of the invention described with reference to the accompanying drawings in which:

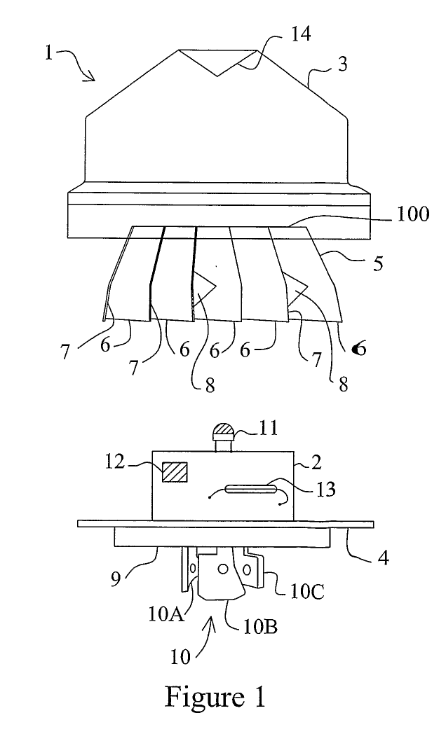

FIG. 1 illustrates an exploded view of a part of a power controller;

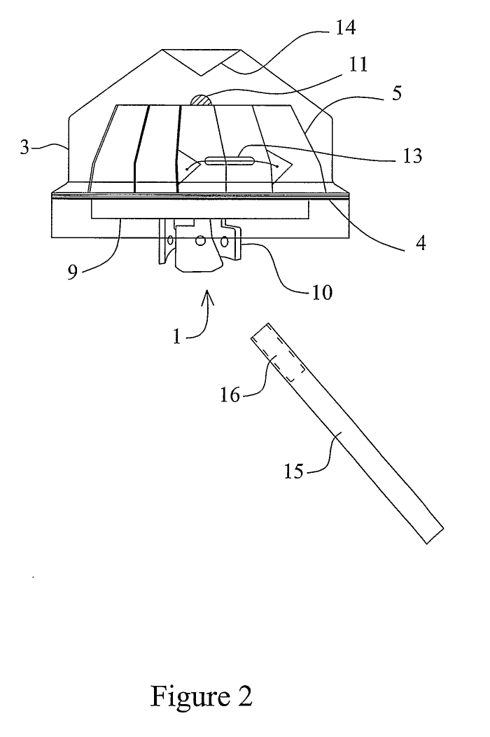

FIG. 2 illustrates a view of the power controller part of FIG. 1 in assembled form together with a remote magnetic wand stimulus means;

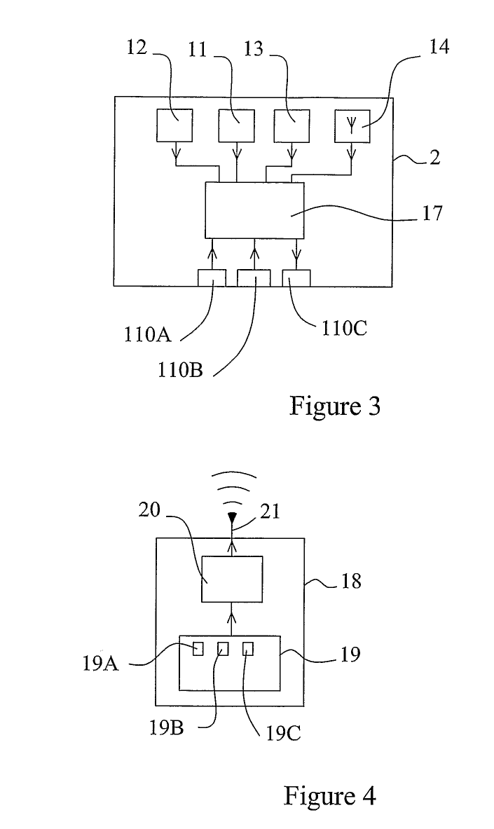

FIG. 3 schematically illustrates the structure of a control unit of the power controller of FIGS. 1 and 2;

FIG. 4 schematically illustrates the structure of a wireless remote unit of the power controller of FIGS. 1 and 2;

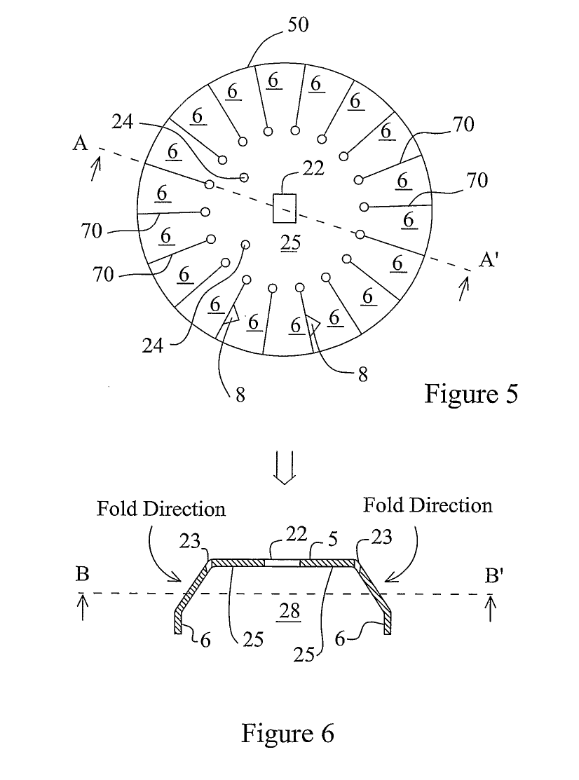

FIG. 5 illustrates a view of a heat sink structure immediately prior to folding of petal structures thereof to form a concavity defined by interleaved vane members;

FIG. 6 schematically illustrates a view of the heat sink structure of FIG. 5 subsequent to folding of the petal structures thereof and viewed across the axis A-A′;

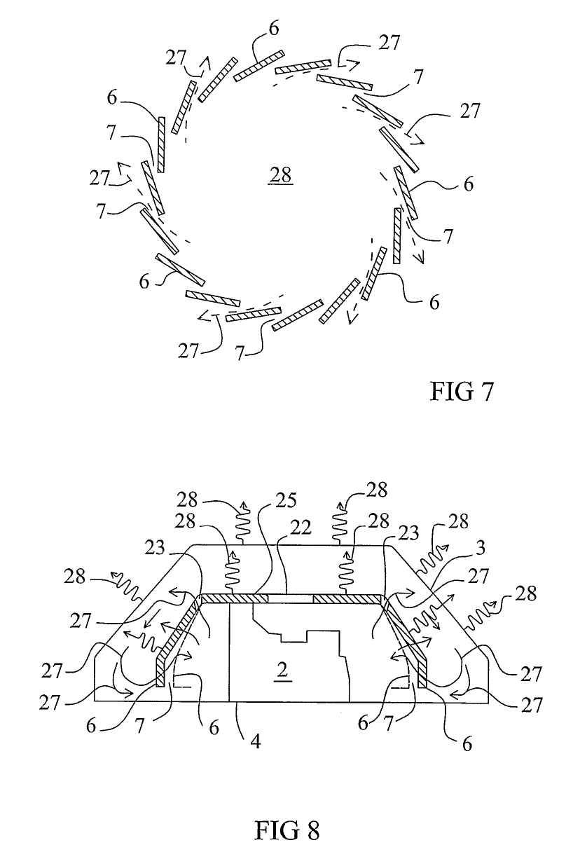

FIG. 7 schematically illustrates a view upwardly across the axis B-B′ of FIG. 6, illustrating a view of the interleaving and partial overlapping of neighbouring successive vane members of a circular array of vane members formed by the heat sink of FIG. 6 defining fluid ventilation ducts and a fluid ventilation conduit;

FIG. 8 schematically illustrates the general path of a convective air flow cycle stimulated by the heat sink of FIGS. 6 and 7 in use in the power controller part of FIGS. 1 and 2, together with the resultant radiant heat transfer outwardly of the power controller;

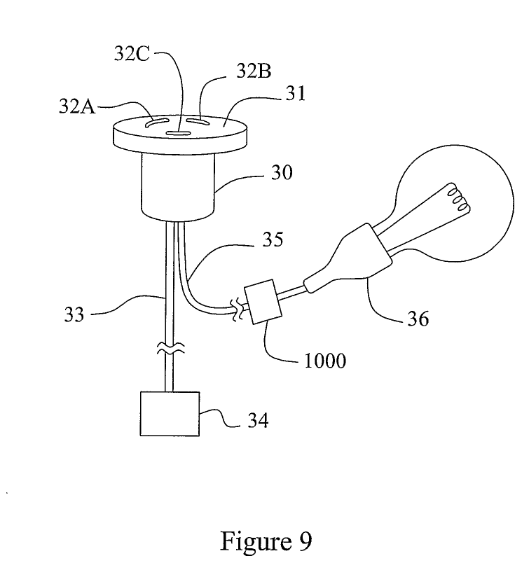

FIG. 9 schematically illustrates a connector means in the form of a three-hole socket to which the power controller part of FIGS. 1 and 2 is detachably attachable to electrically connect the control unit of the power controller in series connection between a light and the power source serving the light;

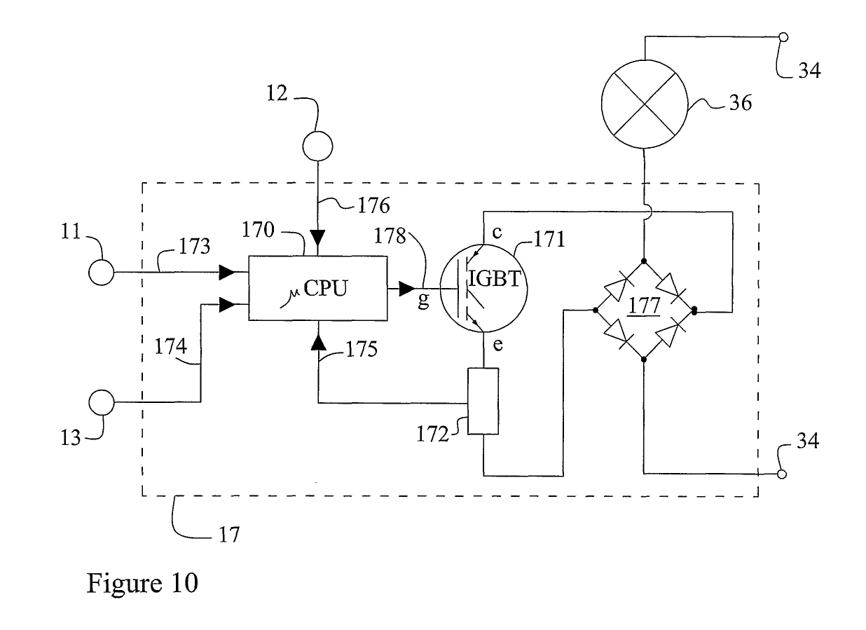

FIG. 10 schematically illustrates circuitry of the control unit.

In the drawings like articles are assigned like reference symbols.

Referring to FIG. 1 and FIG. 9, there is schematically illustrated, respectively, an exploded view of a detachable part of a power controller according to a preferred embodiment of the present invention (FIG. 1), and a fixed part of the power controller (FIG. 9) to which the detachable part is attachable in use.

Referring to FIG. 1, the detachable part (1) of the power controller includes a transparent casing (3, 4) made of UV stabilised polycarbonate or other suitable material transparent to Infra-Red radiation and/or Radio Frequency (RF) radiation. The casing comprises a generally flat circular base (4) and a concave cup-shaped or generally dome-like cover portion (3) defining a concavity reached through an opening in the cover member defined by the periphery of the terminal edges of the cover portion. The base portion (4) is dimensioned to intimately fit within and against the peripheral edges of the cover portion of the opening thereof so as to abut or engage with all parts of the peripheral edge of the cover portion thereby to form a substantially waterproof seal between the outer edges of the base portion (4) and all parts of the peripheral edge of the opening of the cover portion. In this way, when the cover portion (3) is connected to the base portion (4) in use, the concavity defined by the shape of the former is sealed from the environment outside both cover portions by the sealing interface formed with the base portion (4) of the casing.

Mounted upon a surface of the base portion (4) of the casing facing inwardly to the concavity defined by the cover portion of the casing in use, is a control unit (2) arranged to control the delivery of power to an electrical light. The control unit (2) includes an Infra-Red (IR) photosensor (11), a magnetic reed switch (13), and a temperature sensor (12) each of which is operably connected to control circuitry (not shown) within the control unit.

The detachable part (1) of the power controller further includes a heat sink (5) comprising a substantially flat circular cover plate portion (100) from the peripheral edges of which extends a circular array of a plurality of vane members (6) which collectively, together with the cover portion, define a concavity entered through an opening collectively defined by the peripheral edges of the terminal ends of successive vane members of the heat sink. The dimensions of both the cover member (100) and vane members (6) are chosen such that the concavity defined thereby is dimensioned to accept the control unit (2) over and surrounding which the heat sink (5) is placed in use.

Each of the vane members (6) of the heat sink presents a generally flat surface to the inner concavity defined by the heat sink, and each vane member is angled or titled so as to obliquely face the inner concavity of the heat sink. Each of the vane members is positioned in the array of vane members to collectively surround the control unit (2) in use, and each of the vane members is dimensioned and arranged to partially overlap with a neighbouring vane member of the array in separated opposition thereto to define fluid ventilation inlet/outlet ducts (7). The extent of separation between overlapping parts of neighbouring vane members, and thereby the dimensions of fluid ventilation ducts in question, are determined by the extent of angling of the vane members relative to the inner concavity of the heat sink. That is to say, the more obliquely vane members face into the inner concavity of the heat sink, generally the greater will be the extent of separation between the overlapping parts of neighbouring vane members. The vane members (6) extend (in a common general direction) from the circular periphery of the cover member (100) to collectively define a fluid ventilation conduit (not shown) in fluid communication with the fluid ventilation ducts which surround it. The cover portion (100) of the heat sink possesses an aperture (item 22 of FIGS. 5 and 6) forming a fluid outflow opening at an end of the ventilation conduit defined by the heat sink, for the outlet of fluid drawn into the fluid ventilation conduit e.g. through fluid ventilation inlet ducts at the sides thereof, or underneath the vane members through gaps between them and the opposing surface of the base portion (4) of the casing. The outflow opening is also dimensioned to admit the IR photosensor (11) to pass therethrough thereby to protrude from the outwardly presented upper surface of the cover member (100) in use. Furthermore, slots (8) are formed in the sides of two of the vane members permitting signal conduit wires to pass therethrough from the magnetic reed switch (13) of a control unit (2) in use. This enables the magnetic reed switch (13) to be positioned outside the heat sink in use while the body of the control unit (2) to which the reed switch is operably connected is located within the concavity of the heat sink. These slots are shown as notches in the sides of vanes which do not extend to the ends of the vanes containing them. In other embodiments the notches (8) could so extend to the terminal free ends of the vanes in question thereby to form open slots enabling a heat sink to be placed directly over a control unit with the slots accepting the connecting wires of the reed switch without obstruction.

The base portion (4) of the casing (1) includes a group (10) of prongs formed of conductive material such as metal, which extend outwardly of the side of the base portion opposite to that upon which the control unit (2) is mounted. The group of prongs (10) comprises three separate prongs (10A, 10B, 10C) a first of which (10A) is electrically connected to the power input terminal of the control unit (2) and is operable to conduct electrical power to the control unit from the power source employed in powering a light. A second of the three prongs (10B) is connected to the electrical “neutral” input terminal of the control unit (2) and is arranged to connect to the corresponding neutral terminal of the aforementioned power source. A third of the prongs (10C) is connected to the electrical power output terminal of the control unit (2) and is arranged to connect to the power output line leading to the light being controlled by the power controller in use.

Referring to FIG. 9, there is schematically illustrated a fixed portion of the power controller according to an embodiment of the present invention, the fixed portion forming a power source connector arranged to connect to the power source (34) from which the light (36) receives power in use such that the power from the power source passes though the power source connector means (30) and subsequently through the power control unit (2) in use before reaching the light. The power source connector (30) is connected to the power source (34) via a power conduit cable, and is connected to the light (36) by separate power conduit cable (35) such that the power source connector (30) is in series electrical connection between the power source (34) and the light (36) served by the power source. The power source connector (30) includes a socket portion (31) including an array of three socket orifices (32A, 32B, 32C) each being reciprocally shaped with respect to a corresponding one of the three prongs (10A, 10B, 10C) of the base portion (4) of the cover member such that each prong of the latter is intimately received within the corresponding reciprocally shaped socket orifice of the former. The result is that the casing base portion is detachably attachable to the power source connector means (30), the prongs (10) being operably connected to the control unit (2) mounted upon the casing base portion, to convey power from the power source (34) of the light, to the light via the control unit when the casing is attached to the power source connector (30) in use. Power delivery may be made via an electronic power transformer unit (1000) such as would be readily apparent to the skilled person, placed between the power output of the power controller and the power input of the light. The control unit of the power controller may be configurable to appropriately deliver power to the light indirectly via such a transformer.

FIG. 2 illustrates a view of the detachable portion of (1) of the power controller illustrated in FIG. 1, but in fully assembled form. It will be noted that the magnetic reed switch (13) of the control unit (2) is positioned outside the heat sink (5) in the space between the heat sink and the domed cover portion (3) of the casing. The magnetic reed switch being operably connected to the body of the control unit (2) underneath the heat sink via connecting signal wires passing through slots (8) formed in two of the vane members of the heat sink. A neoprene (or other suitable material) foam ring (9) is attached (e.g. glued) to the underside of the casing base portion (4) from which the group of prongs (10) extends. The foam ring (9) encircles the prongs and is arranged to press against the power source connector (30) to encircle the corresponding array of socket orifices (32A-32C) of the power source connector (30) thereby to provide a watertight seal surrounding the prongs and the sockets when the casing is plugged into the power source connector in use.

The power controller also includes a magnetic wand (15) comprising a rod or stem of rigid material within an end of which is mounted a permanent magnet (16) possessing a magnetic field of a strength sufficient to be detected by the magnetic reed switch (13) at a range of several centimetres separation.

FIG. 3 schematically illustrates a representation of the functional components of the control unit (2) of the power controller according to a preferred embodiment of the present invention. The power controller may comprise a printed circuit board upon which is mounted a power regulator unit (17) containing power regulating circuitry (not shown) for regulating the amount/fraction of power delivered to the light from the power source serving the light. The power regulator unit includes components and means for achieving this such as would be readily apparent to the skilled person, and shall not be described in detail here. Power transformer circuitry may be employed to this end, but preferred embodiments of the invention employ transistors to scale the received power to produce a desired fraction thereof for delivery to the light. Preferably, insulated gate bipolar transistors (IGBT) are used to this end since this results in low signal noise within the circuitry.

The power regulator unit (17) includes central processing unit CPU (not shown), a temperature sensor (12), an IR photosensor (11), a magnetic reed switch (13), and a microwave/RF antenna (14). In preferred embodiments the antennae (14) is dispensed with, or alternatively the IR sensor (11) may be dispensed with. The power controller also includes a power input terminal (110A) for receiving power the delivery of which, to a light, is to be controller by the power control unit, a power output terminal (110C) for the output of power from the control unit to the light, and a neutral power line connector terminal (110B) for connecting to the neutral line of the power source serving the light in question and to provide a signal path into the control unit (2) (e.g. to the power regulator and CPU) via the reed switch (13) thereof. Each of the aforementioned components of the control unit is connected to a respective signal input/output port of the CPU. The CPU contains a programmable memory means containing power control instructions which, when implemented by the CPU, control the power regulating circuitry in such a way as to deliver to the light a desired amount of the power received by the control unit according to signals received by CPU from any one or more of the IR photodetector (11), and/or the antennae (14) and either of the temperature sensor (12) and the magnetic reed switch (13).

The control unit is configurable to any of a plurality of modes of operation to control power delivery to the light and is responsive to a magnetic stimulus wirelessly conveyed to the magnetic reed switch (13) from outside the casing (3) so as to configure the CPU to a selected mode of operation determined by the magnetic stimulus. The control unit is also arranged to receive wireless IR control signals conveyed to the IR photosensor (11) from outside the casing, and to control the delivery of power to the light according to the IR control signals it receives. The response of the control unit to given IR control signals differs according to the mode of operation to which it has been configured in response to a previous magnetic stimulus detected by the magnetic reed switch (13) of the control unit. In other embodiments, the wireless control signals may be conveyed via microwave/RF transmissions, in which case the CPU is responsive to signals received by the antenna (14) of the control unit.

Referring to FIG. 2, the magnetic stimulus to which the magnetic reed switch and the control unit are responsive, is provided by placing the permanent magnet (16) of the remote stem portion (15) of the power controller in suitable proximity to the magnetic reed switch thereby to cause the magnetic reed switch to detect the presence of the magnetic stimulus thereby to generate or to cause the generation (within the CPU) of a configure signal to which the CPU responds by configuring the control unit to a mode of operation determined by the nature or form of the magnetic stimulus in question. In preferred embodiments the CPU is responsive to these configure signals to configure the CPU into an activated mode from a deactivated mode (and vice versa) wherein the deactivated mode is a power-down mode in which substantially no power is delivered to the light, whereas the activated mode places the CPU in an activated state of readiness for use in which it may controllably deliver power to the light.

Referring to FIG. 4, there is schematically illustrated a further component of a preferred embodiment of the power controller of this invention comprising a remote handset unit (18) outside the casing (3) of the power controller operable to wirelessly transmit IR (or RF) control signals to the control unit (2) located within the casing. The remote handset includes a keypad (19) comprising an array of manually operable keys (19A, 19B, 19C etc) each of which may be configured to elicit a pre-programmed power control response from the control unit (2) of the power controller as described below. The remote handset can also include a processor unit (20) for programmably storing power control configuration data, and an IR (or RF antennae) transmission unit (21) for wirelessly transmitting (either using IR radiation or RF radiation) control signals and programming data to the control unit (2) of the power controller. The control unit (2) is responsive to a predetermined magnetic stimulus to configure to a programming mode in which it is responsive to wireless IR/RF control signals from the remote handset so as to be programmed thereby to respond in a predetermined way to a predetermined operation of the keypad of the remote handset (18).

The control unit is configurable to a selected mode of operation according to a magnetic stimulus from the permanent magnet (16) of the wand (15) having a form chosen from any of:
(a) the duration of a given magnetic stimulus-determined by the duration for which the permanent magnet (16) is placed in detectable proximity to the magnetic reed switch (13);
(b) the number of a succession of magnetic stimuli—determined by the number of times the permanent magnet is brought in to detectable proximity to the magnetic reed switch (e.g. within a given interval of time);
(c) the rate of receipt of successive magnetic stimuli by the control unit;
(d) the magnitude of a given magnetic stimulus—determined by the proximity and/or strength of the permanent magnet of the wand.

The CPU of the control unit may be programmed/programmable to respond in a predetermined way to enter a predetermined mode of operation in response to magnetic stimuli having any one or more of the stimulus forms (a) to (d) above.

The magnetically activated switch (13) may perform three distinct functions. The main use may be to set the dimmer module into program or learn mode. This could be a “one time only” step and could be performed at the time the unit is installed.

The three such switching functions performed by the magnetically activated switch may be:

(A) Setting the control unit into program or “learn” mode. This procedure allows an individual to permanently program any standard remote control handset key or function into the module dimmer controller circuitry until such time as it is reprogrammed. The procedure for programming is simply to tap or swipe the module housing with the magnet end of the wand in close proximity to the magnetic switch a designated number of times. The control unit may be operable to acknowledge when it has entered program mode. Once the module has acknowledged it is in the program mode, the remote control handset may be directed toward the IR/RF of the control unit and the appropriate button(s) on the remote handset pressed for a few seconds. The circuit may be arranged to acknowledge that it has received the programming signal and the process must be repeated for verification purposes in order to successfully complete the programming procedure. Once the verification signal has been programmed into the module the circuit may perform a full dimming cycle to indicate successful programming i.e. it may be arranged to acknowledge that it has been successfully programmed as per the previous programming steps;

(B) Lamp on and off switch. By tapping or swiping the module housing only once in close proximity to the magnetic switch, the lamp may either change from the off state to the on state where the light level setting may be the one previously programmed into the module or it may switch from the selected light on setting to the off state;

(C) Lamp dimmer setting control switch. By holding and retaining the magnet end of the wand in close proximity to the magnetic switch for a few seconds the control unit may be arranged to respond by causing the lamp to go through repetitive dimming and brightening cycles. When the magnet is removed, the control unit may respond by causing the lamp to remain illuminated (or not) at that level.

An example of an aspect of the operation of the power controller is given below.

Wireless Controlled Intelligent Outdoor Dimmer Module

The following example relates to an implementation of an embodiment of the invention as a weatherproof, secure, remote controlled, intelligent, incandescent light dimmer module intended primarily for outdoor use, although it can also be used indoors.

The module is used in conjunction with an industry standard NEMA “twist lock” three terminal socket wired appropriately to any mains voltage tungsten incandescent lamp of load rating 40 to 300 Watts or to any compatible single or multiple low voltage halogen electronic transformer(s) where the total transformer VA rating does not exceed 300 Watts.

The example combines a watertight case (3,4) with an integral industry standard three terminal NEMA style connector (10). By incorporating a magnetically activated reed switch (13) mounted inside the casing, there is no need for external conventional touch switches or push button switches, thus eliminating moisture, shock hazards, and false triggering issues. The dimmer utilises a microprocessor in its construction and hence many advanced features are possible. The microprocessor monitors both overload and overheating conditions and will take appropriate action to protect the electronics by shutting down the circuit in the event either condition is detected. The “soft start” (of the lamp) feature considerably lengthens the life of the bulb.

IGBT (Insulated Gate Bipolar Transistor) technology incorporated in the dimmer results in very low noise generated by this circuit.

The lamps can be switched on and off or be cycled from a low to a high or a high to a low light level by a single button press on the remote control.

A magnetically activated switch (13) is used to set the module into program or “learn” mode. The module can be programmed to “learn” a remote control button (function), which is then used to control the dimmer. This gives the user unique (secure) control of that dimmer. Magnetically activating the “learn” mode reed (or Hall effect) switch by tapping or swiping a magnetic wand (15) a designated number of times in close proximity to the reed switch and transmitting the desired remote control signal to the module in the correct sequence performs this. The dimmer module can be reprogrammed as many times as required and all stored settings will be retained for many years even if the power is removed due to the use of non-volatile memory within the dimmer circuit.

The magnetically activated switch (13) is connected to the dimmer circuit touch-switch input resistor network of a dimmer control circuit (e.g. of a conventional touch-switch type) and also the neutral mains (power source) terminal (110B) via a solder tag inside the casing. It is mounted between the heat sink (5) and the inside wall of the casing (3). Slots (8) are cut away from the heat sink fins (6) to allow the switch (13) to be connected inside to the Printed Circuit Board (PCB) and neutral terminal (110B).

A magnetic wand (15) is used to activate the dimmer program mode switch (13). The wand is tapped or swiped in close proximity to the program mode switch (13) located inside the dimmer module housing (3) a designated number of times in rapid succession to set the dimmer into program mode.

An aluminium heat sink (5) is designed in a turbine style to offer maximum surface area and to circulate the generated heat around the inside of the housing (3) ensuring optimum heat transfer to the outside world. The heat sink has a circular flat top with an aperture cut out to accommodate an Infrared (IR) sensor (11) or an aerial and two small holes (24, FIG. 5) are drilled out to secure it directly to a bridge rectifier and IGBT device of the control unit. A number of slightly larger holes (23, FIG. 5) are drilled out around the top surface edge of the heatsink to assist in the cooling dynamics. The dimmer control unit (2) and internal mains terminals (10) are completely surrounded (and isolated) on the top and sides by the heat sink (5).

A highly polished mirrored inverted cone (14) can be fitted to the inside top of the cover portion (3) of the casing positioned to converge to a point directly over the IR detector unit (11) to reflect any stray IR back to the detector (11), widening reception angles and enhancing reception of IR transmissions to the dimmer module.

In alternative, and preferred, embodiments, the inverted cove (14) is dispensed with and the IR detector (11) is positioned above the outwardly presented surface of the cover portion (100) of the heat sink and is positionable to “face” any desired direction (e.g. towards the side of the cover portion of the casing).

The main weatherproof casing (3,4) for the dimmer electronics and heat sink utilises a case made of UV stabilised polycarbonate or other suitable material facilitating the use of IR as well as Radio Frequency (RF) as a communications medium to or from the dimmer module.

A standard NEMA style three connector terminal arrangement (10) is located at the base portion (4) of the module casing. These terminals are used for Line In, Line Out and Neutral connections. The dimmer electronics and components are mounted on a printed circuit board PCB (not shown) which is soldered down internally to solder tags connected to the line in and line out terminals. The cover portion (3) of the casing is placed onto the cover base portion (4) and secured into place by gluing, ultrasonically welding or other appropriate means. The three connector terminals (10), the cover portion of the casing (3) and the casing base portion (4) can be further sealed by the use of an appropriate adhesive placed on and around all joints and apertures to attain a very high level of weatherproofing.

A neoprene (or other suitable material) foam ring (9) is stuck down to the underside of the casing base 4 (external side). This acts as a water resistant seal between a standard NEMA style socket and the dimmer module terminals (10).

To regulate the power to the incandescent lamp (36) in a manner that gives low inherent losses within the power controller, phase control technique is used in preferred embodiments. In conventional “leading edge” phase control, a triac is used to switch on a lamp at a point in the cycle of the mains power supply dependent on the required brightness level of the lamp. The power controller may be synchronised to the zero-crossing of the mains power voltage wave form, and be arranged to delay the firing of the triac in proportion to the brightness required. With full brightness of the light, the triac is fired very shortly after a zero crossing of the mains voltage wave form. At minimum brightness of the light, the triac is fired much later in the half cycle of the mains voltage wave form, close to the next zero-crossing. This regime is repeated in the next (opposite polarity) half cycle of the mains voltage power wave form. Because a triac device cannot be turned off after it has been fired by external means (it only turns off or resets as the current flow through commutates through the zero value), this is the only phase control regime possible with triac-based power controller circuitry.

Unfortunately, triac dimmers have many disadvantages. When the lamp/light is switched on in mid-cycle, the current through the lamp suddenly rises, causing conducted and radiated interference (EMI). An inductive filter is generally required to be fitted to triac circuitry of this type to suppress this interference and this component is a source of acoustic noise (buzzing) within the circuitry. At initial turn on of the light with the light in a cold state, the surge current through the light can be high and this causes a thermal and mechanical shock to the light filament, reducing the useable lifetime of the light. Also, an overload condition such as a short-circuit condition within a failed light may be difficult to protect against as the triac circuitry cannot be turned off in response to the detection of this condition. Triac circuits must be protected by fuses, which are often non-resettable by the control circuitry itself or the user.

In preferred embodiments of the present invention, an insulated gate bi-polar transistor (IGBT) semi-conductor switching device is employed which can be turned on or off at will. The IGBT switching device can easily be applied to an AC (alternating current) control function by the addition of a full-wave rectifier (e.g. a bridge rectifier). Such a device enables the design of a “reverse” phase dimmer, which operates in the opposite manner to the triac circuitry described above. The light (36) is turned on at the zero-crossing of the voltage wave form of the mains (34) power source, and the current flowing through the lamp “soft starts” in conjunction with the rate of rise of the mains voltage sinusiodal wave form. Power delivery to the light, and therefore the brightness of the incandescent light, is controlled by turning off the IGBT device at the appropriate point in the half-cycle of the voltage waveform. This turn off is performed in a relatively slow manner to avoid generating interference. Consequently, an interference filter is generally unnecessary, and avoids acoustic noise (e.g. buzzing) of the type associated with triac circuits.

Protection circuitry is included in preferred embodiments of the invention in this context, within the power controller to guard against overload by turning off the IGBT if a safe current level is exceeded, and this overload monitoring may be implemented on a rapid cycle-by-cycle basis. The provision of safety fuses is unnecessary as the controller can be arranged to shutdown if inadvertently overloaded. This is preferably in conjunction with the thermal regulating function described above in which a thermal sensing unit within the power controller is employed, the power controller being operable to shutdown in response to a thermal overload and to restart (if programmed to do so) when the temperature of the power controller, as determined by the thermal sensing unit, is sufficiently lower. In this manner, normal operation may be automatically resumed when overload is removed.

FIG. 10 schematically illustrates an example of a preferred arrangement of circuitry provided within the power regulator unit (17) of the control unit of the power controller.

The power regulator unit (17) includes a CPU (170) in the form of a microprocessor possessing four microprocessor signal input ports. A first signal input port (173) is arranged to receive detection signals from the IR photosensor (11) conveying control signals to the CPU for use thereby in controlling the delivery of power to the light (36). In other embodiments the first signal input port (173) may be arranged to receive RF/microwave antenna signals conveying control signals, or the CPU may have an additional dedicated RF/microwave input signal port in addition to the IR photosensor signal port. The CPU unit has second and third input ports arranged to receive second and third input signals (174, 176 respectively) in the form of configure signals generated by the magnetic reed switch (13) and thermo-regulation signals generated by the temperature sensor unit (12) conveying to the CPU the temperature measured thereby. The fourth processor input port upon which the CPU is arranged to receive a power overload control signal (175) generated by a current sensor unit (172) arranged to monitor mains-derived current passing through the power regulator unit, and to generate an overload control signal (175) when it determines the level of current to exceed a predetermined threshold value indicating potential damage to circuit components within the power regulator unit. The CPU is arranged to be responsive to such an overload control signal to shut down the power regulator unit thereby protecting the components within it.

The CPU is arranged to generate power control signals (178) in response to the aforementioned input signals, and to output those gate control signals to an IGBP (171) connected thereto.

The power regulator unit includes an IGBT (171) comprising a gate (g) connected to the gate control signal output port of the CPU and operable to receive power control signals (178) generated by the CPU for the purposes of switching the IGBT on or off in accordance with the power delivery control function being performed by the CPU. The emitter (e) of the IGBT is connected to the input of the current sensor unit (172) which is arranged to monitor the level of current output by the IBGT unit, for the purposes of determining whether an overload control signal is required to be issued to the CPU as discussed above. Current output from the emitter of the IGBT is conveyed from the current sensor unit (172) to a DC (direct current) input of a full-wave bridge rectifier unit (177). The DC output terminal of the full-wave rectifier unit is connected to the collector input port (c) of the IGBT unit. In this way, current from the full-wave rectifier unit passes from the DC output port thereof, to the collector terminal of the IGBT unit, and depending upon whether or not gate control signal (178) issued to the gate (g) of the IGBT unit permits it, current received by the IGBT unit is output at the emitter (e) thereof for input to the DC input port of the full-wave rectifier unit via the current sensor unit (172). The input-output ports of the full-wave rectifier unit are connected in electrical series connection with the light (36) between the terminals of the power source (34) serving the light.

Consequently, as will be readily understood by the skilled person, the delivery of power to the light (36) from the power source (34) serving the light, may be controlled by suitably controlling the switching on and off of the IGBT unit, through which electrical current to the light is directed, by an appropriate choice of IGBT gate signal (178).

The Heat Sink

As found in most power control circuits, a few watts of power is generated by the electronic circuitry, namely the bridge rectifier and the power IGBT (Insulated Gate Bipolar Transistor). The power generated becomes greater as the current in the circuit increases according to Ohms Law.

This raises the problem that with an encased control unit, with a limited supply of free air to cool the components, the internal air and component temperature will rise to such a level that damage will often occur to the circuitry. This can potentially cause self-destruction or at best a degradation of the electronic components if it is not dissipated away by some means.

The control unit (2) includes a temperature sensor (12) arranged to measure the temperature within the casing and to convey temperature measurement signals to the CPU. The CPU is responsive to signals from the temperature sensor to shut down if the measured temperature exceeds a value at which circuit damage is likely to occur, before any damage can occur.

However, it is important to ensure the temperature of the components of the control unit and captive air within the casing (3,4) is kept to a minimum and to prevent shutdown from occurring for convenience to the user. This is achieved using the heat sink (5), a mechanical device constructed of thermally conductive metal preferably attached to the power semiconductors of the power regulator of the control unit (2), e.g. mounted on the printed circuit board.

The heat sink described here aims to ensure the component and air temperature within the casing (3,4) is maintained at a low enough temperature to enable continuous operation of the control unit (2) across a wide ambient temperature range.

FIG. 6 illustrates a cross-sectional view (along axis A-A′) of the plan view of a heat sink plate (50) illustrated in FIG. 5 as a “folded-out” form of the cup-like structure of FIG. 6. The cup-like structure, illustrated in FIG. 6, is formed from the plate (50) of deformable material (e.g. metal) from the edges of which an array of separate spaced cuts (70) is formed each of which cuts extends into the plate in a direction convergent with that of the other cuts (e.g. convergent upon a common focus—aperture 22) but which each terminates at the periphery of the plate to form a radial array of petal structures (6) folded, at the line between neighbouring terminal cut ends, to the same side of the plate (50) to form the vane members thereby to define a fluid ventilation conduit as illustrated in FIG. 6, terminating at the cover portion (25) formed from the central region of the plate (50) at which the cuts (70) terminate. The petal structures (6) are folded at a twisting fold to angle the petal structures such that a partial non-contact overlap occurs between neighbouring vane members as a result of the collective folding of the petal structures, thereby to define fluid ventilation inlet/outlet ducts.

Fluid outlet openings (23) are provided in the plate (50) at the terminal ends of the cuts encircling the periphery of the cover portion (25). These, together with the central fluid outlet aperture (22) thereof, enable the outflow of heated air from the internal concavity/fluid conduit of the heat sink (5). The fluid ventilation ducts may also serve this function.

The heat sink is disposed within the casing in a space between the control unit and parts of the casing, the heat sink including a group of vane members each positioned in a circular array of vane members collectively surrounding the control unit. A cross-sectional view of the array of vane members (6) is illustrated in FIG. 7 as viewed across the axis B-B′ of the cup-like head sink structure of FIG. 6. The vane members (6) are arranged to partially overlap other neighbouring vane of the array in separated opposition thereto to define fluid ventilation inlet/outlet ducts (7), the vane members extending to collectively define the fluid ventilation conduit (28) in fluid communication with the fluid ventilation ducts (7) and within which the control unit is located. The fluid ventilation conduit (28) defines outflow openings (22,23) at the end thereof at which the vane members join the cover portion (25) of the heat sink. These openings serve as an outlet of heated air (27) drawn into the fluid ventilation conduit through fluid ventilation inlet ducts, and the ventilation ducts may also serve as fluid outlets.

Each of the vane members of the heat sink is substantially flat and generally panel-like, and each vane member of the array is arranged to face, in part, the inner volume of the ventilation conduit (28), and to partly face the overlapping part of the generally flat surface of a neighbouring vane member. Each of the vane members is arranged in the array to face obliquely towards the centre of the fluid ventilation conduit volume, being angled relative to the bore of the fluid conduit such that the separation between neighbouring vanes defines a ventilation inlet/outlet duct (7) which extends along a direction generally parallel with overlapping parts of neighbouring vane panel structures. Consequently, the vane members of the heat sink are arranged to define ducts which extend obliquely from/towards the inner periphery of the ventilation conduit but not from/towards the centre of the ventilation conduit volume. The ventilation ducts (7) extend in a direction from/towards the inner volume of the ventilation conduit chosen to produce or facilitate a non-radial (e.g. swirling) movement of air (27) expelled obliquely out from the bore of the ventilation conduit (or drawn obliquely into the bore of the ventilation conduit) through the ventilation ducts.

Terminal free ends of the vanes, defining the opening of the concavity of the heat sink structure, are spaced from the opposing surface of the base portion of the casing thereby to allow cooled air to be drawn into the fluid ventilation conduit from outside the heat sink structure.

All of the vane membranes are partly interleaved between preceding and succeeding vanes or the array. The partially overlapping or interleaving arrangement of neighbouring vane members and the collective positioning of the vane members to collectively define a fluid ventilation conduit duct with fluid outlet opening at one end has been found to be especially efficient at causing an air flow cycle in which air heated by the control unit is caused to flow along the ventilation conduit towards the outlet opening thereof, and outwardly through ventilation ducts, and as a result to cause air outside the ventilation conduit to be drawn into the ventilation conduit through fluid ventilation inlet ducts positioned along the side of the ventilation conduit and/or through the spacing between the terminal free ends of the vane members and the opposing surface of the base of the casing. The air drawn in through the fluid ventilation ducts has been found to be caused to circulate around and among the components of the control unit, to draw heat from the control unit, to expand as a result and to subsequently flow along the fluid conduit towards the outlet opening at an end thereof, and out through ventilation conduits. Heated air expelled obliquely through ventilation conduits is found to circulate around the outer surface of the heat sink and to transfer heat thereto for subsequent radiative transfer therefrom. Once this heated fluid has passed out of the fluid conduit subsequent cooling of this heated air causes the air to descend back towards the heat sink to regions adjacent fluid ventilation ducts so as to be subsequently drawn in to the ventilation conduit through such ducts (or other gaps) in a repeating air-flow cycle. This repeating airflow cycle continuously cools the parts of the control unit inside the ventilation conduit and is schematically illustrated in FIG. 8.

The outlet openings (22,23) of the fluid ventilation conduit are in fluid communication with the fluid ventilation ducts via free space outside the fluid ventilation conduit between the heat sink means and the casing. Thus, whilst in the free space outside the fluid ventilation conduit between the heat sink means and the casing, the heated air may cool down and transfer heat preferably to the outer surface of the heat sink and/or the inner surface of the casing. This transferred heat may then subsequently be radiated away (28) from both the heat sink and the casing. In this way, radiative transfer of heat from the outwardly-presented/visible surfaces of components of the heat sink and power controller may be facilitated by convective heat transfer from the control unit within the heat sink vane array structure.

To assist in increasing the efficiency of radiative heat transfer from the heat sink, the surface of the heat sink presented outwardly towards the casing is matt black in colour, or some other suitable dark colour which enhances the output of thermal radiation therefrom.

The vane members extend to collectively converge towards the outlet openings (22,23) such that the fluid ventilation conduit (28) collectively defined by the vane members is substantially conical having an inner bore which reduces towards the outlet opening. The result is a conical structure of inwardly tilted separate vanes/panel structures inwardly tilted towards a common point of convergence and producing a structure resembling a turbine. This turbine-like structure has been found through experiment to significantly enhance heat transfer from the control unit in use to the heat sink and to the outside world.

During experimentation, the internal temperature of the casing (3,4) was measured by inserting a miniature bead temperature probe into a tightly fitting small bore hole drilled in the base portion of the casing (4). Once the probe bead was secured inside the underside section of the heat sink (being one of a number of designs) and the probe lead was connected to a digital thermometer. Another two digital thermometers measured the ambient temperature outside the casing throughout the experiments.

Many different styles of heat sink were designed and tested. Among those was a conical, turbine style heat sink (as described above) with relatively long but few vanes (about 18), quite wide ventilation ducts between the vanes (e.g. 0.5 mm minimum) plus 18 small diameter ventilation holes (23) drilled around the flat cover portion (25) of the heat sink was constructed and tested. This variation worked surprisingly far better than other dissimilar designs. The final settling internal temperature within the casing should preferably not exceed about 58 or 59 Degrees Celsius at an ambient temperature of 18 to 20 Degrees Celsius if the control unit is to perform adequately without shutting down in higher ambient temperatures of up to 40 Degrees Celsius.

It is to be understood that variations and modifications, such as would be readily apparent to the skilled person, may be made to the embodiments described above without departing from the scope and spirit of the present invention in any of its aspects.

1. A power controller including:
a casing;
a control unit disposed within the casing being configurable to any of a plurality of modes of operation to control power delivery to a light and being responsive to a stimulus wirelessly conveyed thereto from outside the casing to configure to a selected mode of operation determined by the stimulus, the control unit being arranged to receive control signals wirelessly conveyed thereto from outside the casing and to control said power delivery according to the control signals wherein the response of the control unit to control signals differs according to the mode of operation determined by the stimulus.

2. A power controller according to claim 1 in which the control unit is responsive to said stimulus to configure to an activated mode in which it is responsive to said control signals to controllably deliver power to the light from a deactivated mode in which it does not deliver power to the light, and vice versa.

3. A power controller according to claim 1 including a remote unit outside said casing and operable to wirelessly transmit said control signals to the control unit, in which the control unit is responsive to said stimulus to configure to a programming mode in which it is responsive to said control signals to be programmed thereby to respond in a predetermined way to a predetermined operation of the remote unit.

4. A power controller according to claim 1 in which the control unit includes a magnetic detector means and the stimulus is a magnetic field strength in response to which the magnetic detector means is operable to generate a configure signal, wherein the control unit is responsive to the configure signal to configure to a mode of operation determined by the configure signal.

5. A power controller according to claim 4 including a stimulus means remote from the control unit and outside said casing and including a magnetic field means for providing a magnetic field of sufficient strength to be remotely detectable by the magnetic detector.

6. A power controller according to claim 4 in which the control unit is configurable to a selected mode of operation according to any of: the duration of a given configure signal; the number of a succession of configure signals; the rate of receipt of successive configure signals thereby; the magnitude of a given configure signal.

7. A power controller according to claim 6 in which the magnetic field means is a permanent magnet.

8. A power controller according to claim 4 in which the magnetic detector means includes a sensor means including any of: a reed switch; a Hall-Effect switch, a magnetic relay switch; an inductor coil, and the magnetic detector is responsive to said stimulus using the sensor means.

9. A power controller according to claim 1 suitable for outdoor use in which the control unit is encased in a substantially watertight weather-proof casing.

10. A power controller according to claim 1 in which the casing is transparent.

11. A power controller according to claim 1 in which the control signals are conveyed using any of: Infra-red (IR) light; microwaves; radio waves.

12. A power controller according to claim 1 in which the control unit is configurable to a mode of operation in which it is responsive to said control signals to change the amount of electrical power delivered to the light in use to controllably vary the radiant output of the light.

13. A power controller according to claim 1 in which the control unit includes a photo-sensor means within the casing for determining the level of ambient illumination outside the casing, and for configuring the control unit to a mode of operation according to the ambient illumination level so determined.

14. A power controller according to claim 1 including a power source connector means arranged to connect to the power source from which the light receives power in use such that the power from the power source passes through the power controller before reaching the light, wherein the power controller is arranged to control the delivery of power from the power source to the light.

15. A power controller according to claim 14, wherein the casing includes a plurality of prongs extending outwardly thereof and shaped to be intimately received within a reciprocally shaped socket means of the power source connector means such that the casing is detachably attachable to the power source connector means therewith, the prongs being operably connected to the control unit to convey power from the power source to the light via the control unit when the casing is attached to the power source connector means in use.

16. A power controller including:
a casing;
a control unit disposed within the casing and arranged to control power delivery to a light;
a heat sink means disposed within the casing in a space between the control unit and parts of the casing, the heat sink means including a group of vane members each positioned in an array of vane members collectively surrounding at least a part of the control unit in which vane members are arranged to partially overlap a neighbouring vane member in separated opposition thereto to define fluid ventilation ducts, the vane members extending to collectively define a fluid ventilation conduit in fluid communication with the fluid ventilation ducts and within which the at least a part of the control unit is located.

17. A power controller according to claim 16 wherein the fluid ventilation conduit defines an outlet opening at an end thereof for the outflow of fluid drawn into the fluid ventilation conduit.

18. A power controller according to claim 17 in which the outlet opening of the fluid ventilation conduit is in fluid communication with at least some of said fluid ventilation ducts via free space outside the fluid ventilation conduit between the heat sink means and the casing.

19. A power controller according to claim 17 in which the vane members extend to collectively converge towards the outlet opening such that the fluid ventilation conduit collectively defined by the vane members is substantially conical having an inner bore which reduces towards the outlet opening.

20. A power controller according to claim 17 in which the vane members are joined by a cover member which extends over the control unit and within which is formed an aperture defining the outlet opening.

21. A power controller according to claim 20 in which the vane members and the cover member collectively define a concavity within which the control unit is located.

22. A power controller according to claim 20 in which the control unit is connected to the heat sink means.

23. A power controller according to claim 20 in which the control unit is physically attached to the cover member.

24. A power controller according to claim 16 in which the control unit includes temperature monitor means for measuring the temperature within the casing and for configuring the control unit to a deactivated mode when the temperature is measured by the temperature monitor means to exceed a predetermined value.

25. A power controller according to claim 16 in which the surface of the heat sink means presented outwardly towards the casing is matt black in colour.

26. A power controller according to claim 16 in which the separation between partially overlapping parts of neighbouring vane members of the heat sink means is at least 0.5 mm.

27. A power controller according to claim 20 in which the cover member contains a plurality of apertures each of which defines a fluid ventilation outlet opening.

28. A power controller according to claim 16 in which the fluid conduit has a fluid inlet opening at an end of the conduit opposite the end having the fluid outlet opening, and in fluid communication with the free space between the heat sink and the casing outside the heat sink.

29. A power controller according to claim 28 in which the fluid inlet opening faces the part of the casing upon which the control unit is mounted, in spaced opposition thereto.

30. A power controller according to claim 28 in which the parts of the heat sink defining the fluid inlet opening surround the control unit.

31. (canceled)

32. A method of controlling power delivery to a light including:
providing a power controller;
wirelessly conveying a stimulus to the power controller from outside the casing thereof to configure to a selected mode of operation determined by the stimulus; and
wirelessly conveying control signals to the controller from outside the casing to control said power delivery according to the control signals.

33. A method according to claim 32 including providing said stimulus to configure the control unit to an activated mode in which is responsive to said control signals to controllably deliver power to the light from a deactivated mode in which it does not deliver power to the light, or vice versa.

34. A method according to claim 32 including wirelessly transmitting said control signals to the control unit after configuring the power controller to a programming mode in which it is responsive to said control signals to be programmed thereby to respond in a predetermined way to subsequent control signals.

35. A method according to claim 32 in which the stimulus is a magnetic field strength, the method including generating a configure signal using the control unit in response to the stimulus, and configuring the control unit to a mode of operation determined by the configure signal.

36. A method according to claim 35 including configuring the control unit to a selected mode of operation according to any of: the duration of a given configure signal; the number of a succession of configure signals; the rate of receipt of successive configure signals thereby; the magnitude of a given configure signal.

37. A method according to claim 32 including configuring the control unit to a mode of operation in which it is responsive to control signals to change the amount of electrical power delivered to the light in use to controllably vary the radiant output of the light, and wirelessly transmitting such control signals to the control unit.

38. A method according to claim 32 including providing a photo-sensor means within the casing for determining the level of ambient illumination outside the casing, and configuring the control unit to a suitable mode of operation according to the ambient illumination level so determined.

39. A method according to claim 32 including connecting the control unit to the power source from which the light receives power in use, and directing the power from the power source through the control unit before reaching the light, and controlling the delivery of power from the power source to the light using the control unit.

40. A method according to claim 32 including measuring the temperature of the control unit and configuring the control unit to a deactivated mode when the temperature is measured to exceed a predetermined value.
